(19) United States
(12) Patent Application Publication
(10) Pub. No.: US 2002/0008079 A1
(43) Pub. Date: Jan. 24, 2002

(54) Dry etching method for iridium electrode

(76) Inventor: Chee-won Chung, Yongiu-city (KR)

Correspondence Address: The Law Offices of Eugene M. Lee, PLLC, Suite 1200, 2111 Wilson Boulevard, Arlington, VA, 22201, US

(21) Appl. No.: 09/801,730

(22) Filed: Mar. 9, 2001

(30) Foreign Application Priority Data
Mar. 10, 2000 (JP) 00-12055

(51) Int. Cl. H01B 13/00; C23F 1/00; B44C 1/22

(52) U.S. Cl. 216/13; 216/41; 216/67; 216/68; 216/75

(57) ABSTRACT

A dry etching method for an iridium electrode, wherein the dry etching method includes depositing an iridium metal film on a substrate, forming a photoresist mask on the metal film in a predetermined pattern, etching the metal film which is not covered with the photoresist mask in the predetermined pattern by generating plasma using an etch gas containing an inert gas and fluorine-based gas, and removing the photoresist mask. Accordingly, no etch residues remain even if a photoresist is used as an etch mask, and it is not necessary to heat a substrate to a high temperature. In addition, since the selectivity of an iridium electrode with respect to a photoresist mask can be increased, an iridium electrode having a satisfactory etch profile can be formed.

### BACKGROUND OF THE INVENTION

1. Field of the Invention

The present invention relates to a dry etching method for an iridium (Ir) electrode. More particularly, the present invention relates to a dry etching method that can minimize a residue generated during an etching process for forming an Ir electrode.

2. Description of the Related Art

In general, memory devices are composed of transistors and capacitors. A capacitor includes a dielectric and electrodes. Electrodes are formed of materials corresponding to the kind of dielectric used in the capacitor. When a ferroelectric or a high dielectric material is used, it is necessary to crystallize the dielectric at a high temperature. Thus, electrode materials that are not oxidized at a high temperature are required. A dynamic random access memory (DRAM) is a memory device using a capacitor formed of a high dielectric material. A ferroelectric random access memory (FeRAM) is a memory device using a capacitor formed of a ferroelectric.

Electrodes used in a high dielectric capacitor and a ferroelectric capacitor are usually formed of platinum (Pt), ruthenium (Ru), iridium (Ir), palladium (Pd) and oxides thereof. An electrode of such a ferroelectric capacitor has a single metal layer structure or a multilayered structure including a metal layer and an oxide layer.

A process of etching a ferroelectric film and an electrode material is necessary for manufacturing a ferroelectric capacitor. According to the structure of the ferroelectric capacitor, the electrode material and the ferroelectric film may be separately etched using individual masks or may be simultaneously etched using a single mask.

FIG. 1 illustrates the results of etching an iridium (Ir) film using a conventional dry etching method. FIG. 2 illustrates the results of performing a conventional dry etching method for forming a ferroelectric capacitor. As shown in FIGS. 1 and 2, when dry etching is performed using a photoresist mask, since iridium (Ir) is not only slowly etched like platinum but also has a low selectivity with respect to photoresist, the surface of an Ir electrode 2 formed on a substrate 1 is over etched, and an etch residue 3 exists on the surface of the Ir electrode 2 after the etching.

In a single transistor memory device in which a memory device is made using a ferroelectric as a gate dielectric layer without forming a capacitor, that is, in a Metal/Ferroelectric/lnsulator/Silicon Field Effect Transistor (MFIS FET) structure using an insulator to control the reaction between the ferroelectric and the silicon, as depicted in FIG. 3, or in a Metal/Ferroelectric/Silicon Field Effect Transistor (MFS FET) structure without an insulator, as depicted in FIG. 4, a gate electrode and a ferroelectric film, or even a thin insulator, should be simultaneously etched using a single mask.

Noble metals used for gate electrodes are not easily etched. When they are etched, as depicted in FIGS. 3 and 4, etch residues 3 are formed on etched sidewalls due to re-deposition. In addition, as described above, the low etching rate of Ir and the low selectivity of Ir with respect to the mask badly deteriorate the profile of the Ir electrode and the profile of the underlying ferroelectric to 45°.

As described above, when electrodes forming a ferroelectric capacitor are patterned by a dry etching method, since electrodes formed of, for example, Pt, Ir and Ru have very low reactivity, they are not well etched using an etch gas and a chemical reaction. Accordingly, when etching an electrode material such as Pt, Ir or Ru, a large amount of chlorine-based gas having strong reactivity is used to increase an etch rate and remove or decrease an etch residue. In this case, since a typical photoresist mask is vulnerable to the chlorine-based gas, the selectivity of the metals with respect to the photoresist drops significantly. In particular, since the sidewalls of the photoresist mask are also vulnerable to an etch gas, the lateral slope of the photoresist mask of 90° decreases. Mostly, the original shape of the photoresist mask is ruined, and not only the thickness thereof in a vertical direction but also the width thereof in a horizontal direction decrease. As a result, the lateral slope of an etched electrode is 45° or smaller, and the lateral slope of a ferroelectric film is 45° or smaller. Accordingly, the size of a pattern increases as much as the thicknesses of the electrodes and the ferroelectric film so that the size of a unit cell increases.

When etching iridium, a halogen-based gas such as chlorine, fluorine or bromine is used as an etch gas. Usually, a chlorine-based gas, such as Cl₂ or a mixed gas of Cl₂ and BCl₃,or a chlorine-based mixed gas including an inert gas is used. Here, an etch residue such as IrCl₃ or IrCl₄ is observed on the sidewalls of an electrode after an etching process. To prevent the formation of such an etch residue, a method of heating a substrate to 150° C. during an etching process or a method of using helicon antenna plasma etching equipment has been proposed, but they do not substantially prevent the formation of an etch residue.

The formation of an etch residue is unavoidable in a conventional dry etching method. Accordingly, after an etching process, wet cleaning using acid, alcohol or water is required to remove the etch residue.

### SUMMARY OF THE INVENTION

To solve the above problems, a first feature of an embodiment of the present invention is to provide a dry etching method for an iridium (Ir) electrode, which can effectively prevent the formation of an etch residue when an Ir film for an Ir electrode is etched using a photoresist mask.

A second feature of an embodiment of the present invention is to provide a dry etching method for an Ir electrode, which can maintain the selectivity of a photoresist mask high, thereby satisfactorily maintaining the profile of the Ir electrode.

A third feature of an embodiment of the present invention is to provide a dry etching method capable of etching an Ir film for an Ir electrode at a high etch rate.

In an effort to satisfy these and other features of the embodiments of the present invention, an embodiment of the present invention provides a dry etching method for an iridium electrode. The method includes depositing an iridium metal film on a substrate, forming a photoresist mask on the metal film in a predetermined pattern, etching the metal film which is not covered with the photoresist mask in the predetermined pattern by generating plasma using an etch gas containing an inert gas and fluorine-based gas, and removing the photoresist mask.

The fluorine-based gas is C₂ F₆, CF₄, C₃ F₈ or SF₆. Preferably, the inert gas is Ar, He, Ne, Kr or N₂. Also preferably, the plasma is generated by a high density etching apparatus using inductively coupled plasma, and the metal film is etched at room temperature without heating the substrate.

The etch gas contains 30% or more fluorine-based gas. Preferably, the etch gas further contains a chlorine-based gas. Preferably, the content of the fluorine-based gas and the chlorine-based gas with respect to the inert gas is 30% or more. In particular, a fluorine-based gas/chlorine-based gas ratio is 2:1 or greater.

The chlorine-based gas is preferably Cl₂, BCl₃ or SiCl₄. Preferably, the coil radio frequency power of the plasma etching apparatus is 500 W or greater, the gas pressure is 10 mTorr or higher, and the bias voltage of the substrate is 200 V or greater.

These and other features of the present invention will be readily apparent to those of ordinary skill in the art upon review of the detailed description that follows.

### BRIEF DESCRIPTION OF THE DRAWINGS

The above features and advantages of the embodiments of the present invention will become more apparent by describing in detail preferred embodiments thereof with reference to the attached drawings in which:

FIG. 1 illustrates the result of etching an iridium (Ir) film using a conventional dry etching method known in the prior art;

FIG. 2 illustrates the result of performing a conventional dry etching method for forming a ferroelectric capacitor known in the prior art;

FIG. 3 illustrates the result of performing a conventional dry etching method on a Metal/Ferroelectric/lnsulator/Silicon Field Effect Transistor (MFIS FET) known in the prior art;

FIG. 4 illustrates the result of performing a conventional dry etching method on a Metal/Ferroelectric/Silicon Field Effect Transistor (MFS FET) known in the prior art;

FIG. 5 is a line graph illustrating changes in the etch rate of Ir films depending on a change in the concentration of Cl₂/Ar gas, as a result of a test example 1 in which Cl₂/Ar gas is used as an etch gas according to an embodiment of the present invention;

FIG. 6 is a line graph illustrating changes in the etch rate of Ir films depending on a change in the concentration of SiCl₄/Ar gas, as a result of a test example 2 in which SiCl₄/Ar gas is used as an etch gas according to an embodiment of the present invention;

FIG. 7 is a line graph illustrating changes in the etch rate of Ir films depending on a change in the concentration of C₂F₆/Ar gas, as a result of a test example 3 in which C₂F₆/Ar gas is used as an etch gas according to an embodiment of the present invention;

FIG. 8 is a line graph illustrating changes in the etch rate of Ir films depending on a change in the concentration of HBr/Ar gas, as a result of a test example 4 in which HBr/Ar gas is used as an etch gas according to an embodiment of the present invention;

FIG. 9 is a line graph illustrating changes in the etch rate of Ir films depending on a change in the concentration of Cl₂/C₂F₆/Ar gas, as a result of a test example 5 in which Cl₂/C₂F₆/Ar gas is used as an etch gas according to an embodiment of the present invention;

FIG. 10 is a line graph illustrating changes in the etch rate of an Ir film depending on changes in the concentration of etch gas in the test examples 1 through 5 according to an embodiment of the present invention;

FIG. 11 is a photograph illustrating an etch profile resulting from the test example 1 using Cl₂/Ar gas according to an embodiment of the present invention;

FIG. 12 is a photograph illustrating an etch profile resulting from the test example 2 using SiCl₄/Ar gas according to an embodiment of the present invention;

FIG. 13 is a photograph illustrating an etch profile resulting from the test example 3 using C₂F₆/Ar gas according to an embodiment of the present invention;

FIG. 14 is a photograph illustrating an etch profile resulting from the test example 4 using HBr/Ar gas according to an embodiment of the present invention;

FIG. 15 is a photograph illustrating an etch profile resulting from an embodiment using a mixed gas of 30% of C₂F₆/Cl₂ gas having a 1:1 mixture ratio and 70% of Ar gas according to the present invention; and

FIG. 16 is a photograph illustrating an etch profile resulting from an embodiment using a mixed gas of 30% of C₂F₆/Cl₂ gas having a 2:1 mixture ratio and 70% of Ar gas according to the present invention.

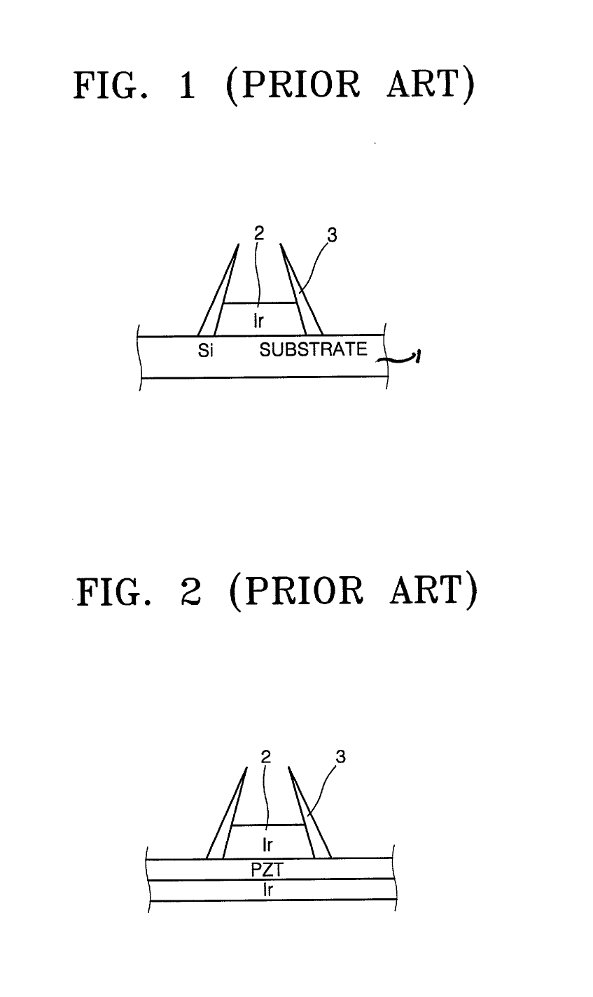

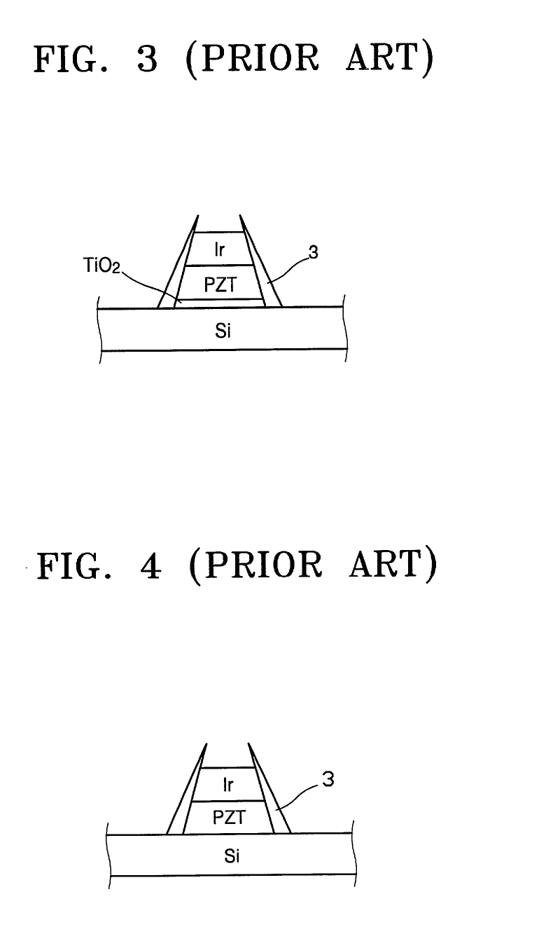

### DETAILED DESCRIPTION OF THE PREFERRED EMBODIMENTS

Korean Patent Application No. 00-12055, filed on Mar. 10, 2000, and entitled: “Dry Etching Method for Iridium Electrode,” is incorporated by reference herein in its entirety.

To overcome the problems of the conventional technology, an embodiment of the present invention provides an optimal etch gas and optimal etch conditions in etching an iridium (Ir) film using a photoresist mask. In particular, a reactive compound having strong volatility is made using a fluorine-based gas rather than a chlorine-based gas and used as an etch gas so that an etch residue does not remain after an etching process. In addition, a small amount of a chlorine-based gas is added to an etch gas in order to prevent mask erosion usually occurring when an excessive quantity of fluorine-based gas is used and improve an etch rate. As a result, a clean etch profile and a proper etch rate can be obtained, and the etching selection ratio of an Ir film to photoresist is increased.

TABLE 1

| Ir compound | Melting point (° C.) |
|---|---|
| Ir(CO)₂Cl₂ | 140 |
| IrCl₃ | 763 |
| IrF₃ | 250 |
| IrF₆ | 44 |

Table 1 shows the melting point of each Ir compound. It was proved that actually the Ir(CO)₂Cl₂ compound is not easily formed. It can be seen that fluorine-based compounds, i.e., IrF₃ and IrF₆, have lower melting points than a chlorine compound, i.e., IrCl₃. Based on these physical characteristics of the Ir compounds, their etch characteristics are examined using a chlorine-based gas, a fluorine-based gas, a bromine-based gas and a mixed gas thereof. The boiling point of Ir(CO)₂Cl₂ is 53° C.

Initially, an Ir film was deposited on a substrate. Then, a photoresist mask was formed on the Ir film in a predetermined pattern. The deposition of the Ir film was performed by a sputtering method, and the photoresist mask was patterned by a typical photolithographic process including coating, baking and dry etching of photoresist. After the Ir film was etched, the photoresist mask was removed using oxygen plasma.

### TEST EXAMPLE 1

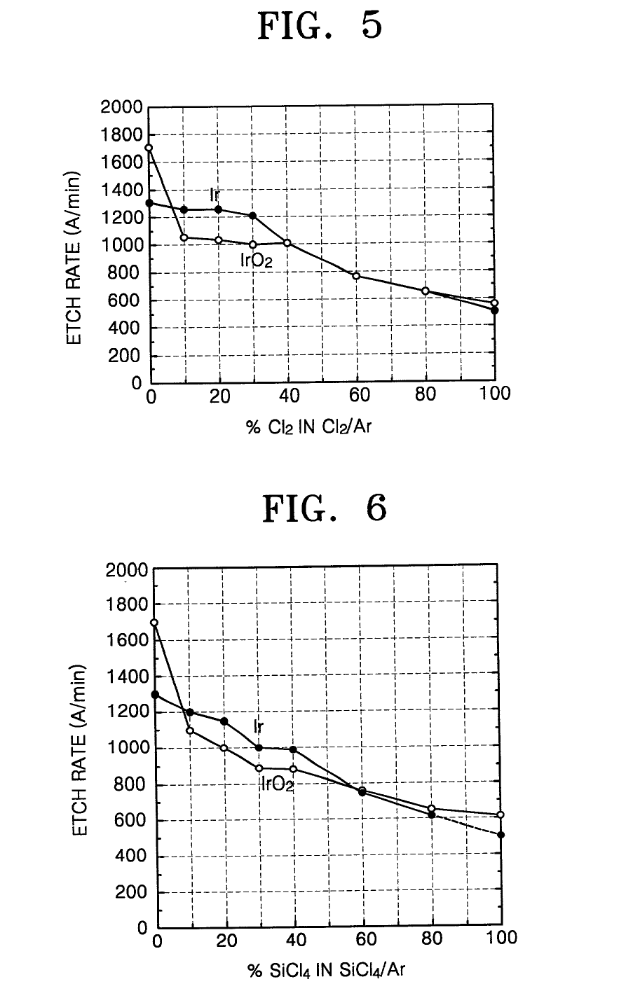

FIG. 5 graphically depicts changes in the etch rate of an Ir film and an IrO₂ film depending on a change in the Cl₂ gas content in Cl₂/Ar gas. In this test, an inductively coupled plasma etching apparatus was used, and Cl₂ gas containing Ar was used as an etch gas. Coil radio frequency (RF) power was set to 700 W, a gas pressure was set to 5 mTorr, a bias voltage to a substrate was set to 300 V, and a total flow rate was set to 30 sccm.

### TEST EXAMPLE 2

FIG. 6 graphically depicts changes in the etch rate of an Ir film and an IrO₂ film depending on a change in the SiCl₄ gas content in SiCl₄/Ar gas. In this test, an inductively coupled plasma etching apparatus was used, and SiCl₄ gas containing Ar was used as an etch gas. Coil RF power was set to 700 W, a gas pressure was set to 5 mTorr, a bias voltage to a substrate was set to 300 V, and a total flow rate was set to 30 sccm.

### TEST EXAMPLE 3

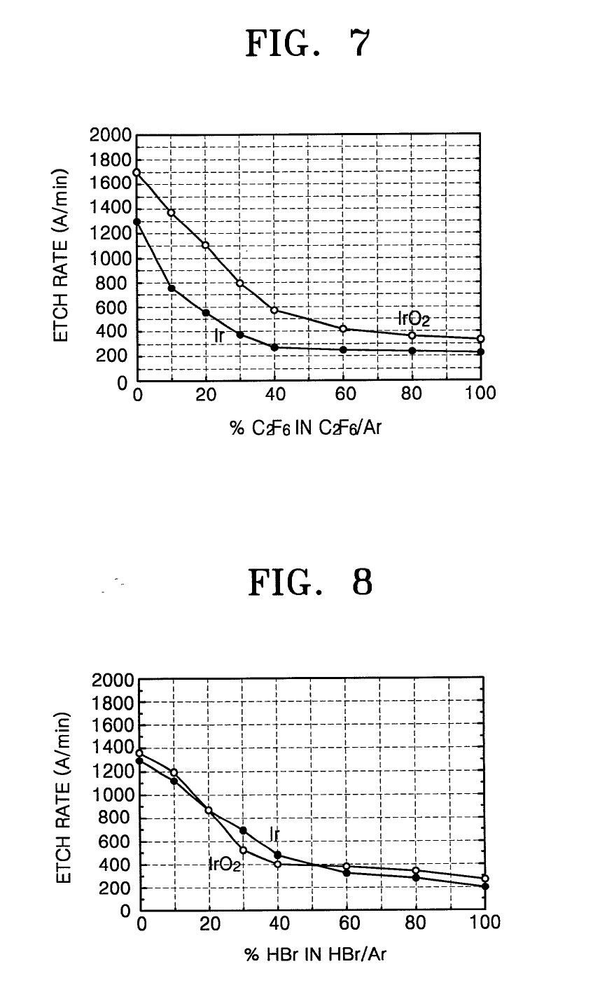

FIG. 7 graphically depicts changes in the etch rate of an Ir film and an IrO₂ film depending on a change in the C₂F₆ gas content in C₂F₆/Ar gas. In this test, an inductively coupled plasma etching apparatus was used, and C₂F₆ gas containing Ar was used as an etch gas. Coil RF power was set to 700 W, a gas pressure was set to 5 mTorr, a bias voltage to a substrate was set to 300 V, and a total flow rate was set to 30 sccm.

### TEST EXAMPLE4

FIG. 8 graphically depicts changes in the etch rate of an Ir film and an IrO₂ film depending on a change in the HBr gas content in HBr/Ar gas. In this test, an inductively coupled plasma etching apparatus was used, and HBr gas containing Ar was used as an etch gas. Coil RF power was set to 700 W, a gas pressure was set to 5 mTorr, a bias voltage to a substrate was set to 300 V, and a total flow rate was set to 30 sccm.

### TEST EXAMPLE 5

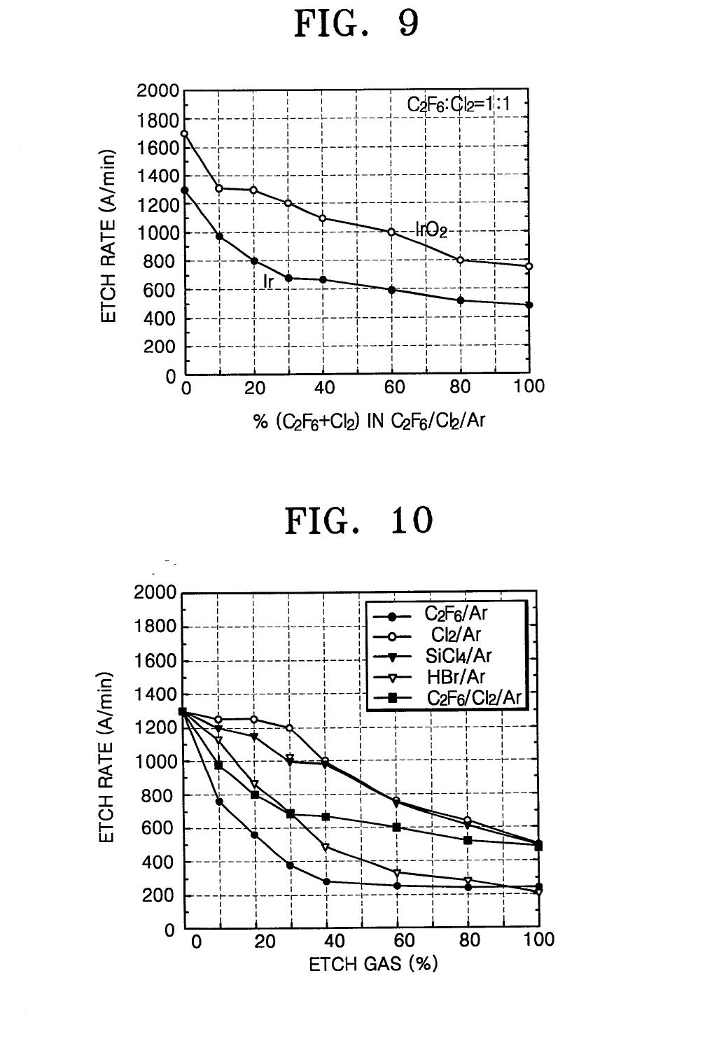

FIG. 9 graphically depicts changes in the etch rate of an Ir film and an IrO₂ film depending on a change in the C₂F₆ +Cl₂ gas content in C₂F₆/Cl₂/Ar gas. In this test, an inductively coupled plasma etching apparatus was used, and C₂F₆ +Cl₂ gas containing Ar was used as an etch gas. Coil RF power was set to 700 W, a gas pressure was set to 5 mTorr, a bias voltage to a substrate was set to 300 V, and a total flow rate was set to 30 sccm. A mixture ratio of C₂F₆ to Cl₂ is 1:1.

FIG. 10 graphically depicts changes in the etch rate of an Ir film and IrO₂ film depending on changes in the gas content of an etch gas in the test examples 1 through 5.

As shown in the test examples 1 through 5, the etch rate of an Ir film tends to decrease as the concentration of an etch gas increases. From this fact, it can be inferred that the etch rate decreases because the sputtering amount decreases due to a decrease in an inert gas contained in an etch gas rather than because the Ir film is etched by chemical reaction. In other words, this fact indicates that an Ir film does not form a chemical compound with most etch gases, but the Ir film is etched by a physical etch mechanism depending on collision of ions. For an etch rate, it can be seen that an Ir film is etched fastest when Cl₂/Ar gas is used as an etch gas and is etched most slowly when C₂F₆/Ar gas is used as an etch gas. A photoresist mask was etched fastest when Cl₂/Ar gas was used as an etch gas and most slowly etched when C₂F₆/Ar gas was used as an etch gas. When a mixed gas of Cl₂ and C₂ F₆ was used as an etch gas, an etch rate in about the middle of the etch rates of the two gases was observed.

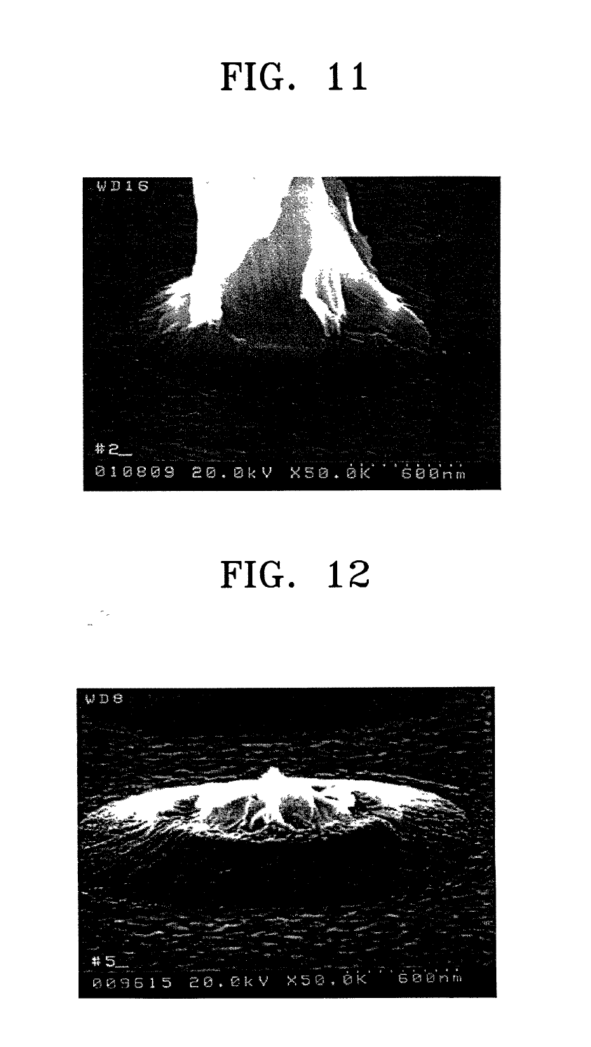

FIGS. 11 through 16 illustrate etch profiles of an Ir film, which are obtained from such test examples as described above.

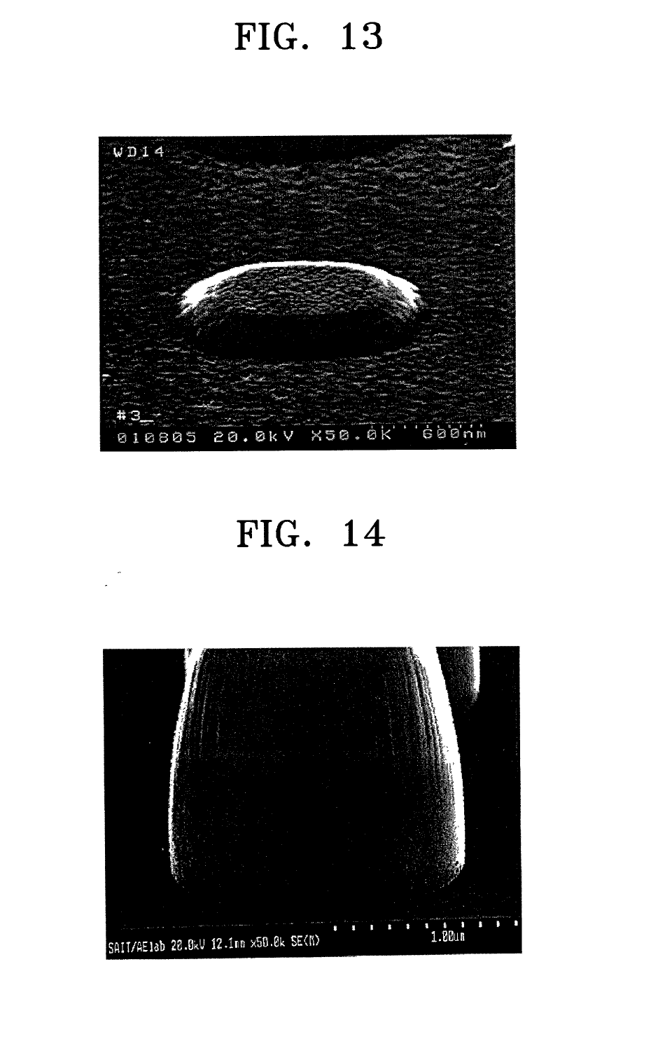

FIG. 11 illustrates the result of the test example 1 using Cl₂/Ar gas. FIG. 12 illustrates the result of the test example 2 using SiCl₄/Ar gas. FIG. 14 illustrates the result of the test example 4 using HBr/Ar gas. In FIG. 14, etch residues remain on the sidewalls of an etched film. FIG. 13 illustrates the result of the test example 3 using C₂ /Ar gas. Here, no etch residue remain when C₂ F₆ gas is 30% or more.

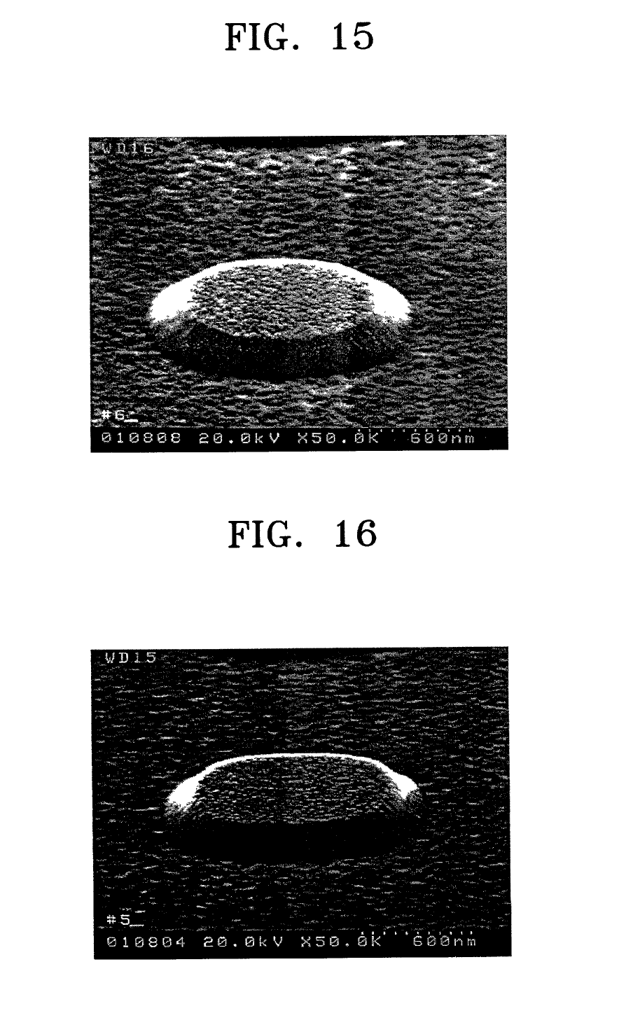

Accordingly, it can be concluded that it is advantageous to use a fluorine-based gas rather than a chlorine-based gas or a bromine-based gas when an Ir film is etched using a photoresist. However, an etch rate is low when C₂ F₆/Ar gas is used although a clean profile can be obtained after an etching process. To improve the etch rate, it is preferable to use a mixed gas of C₂ F₆/Cl₂ and Ar containing a predetermined amount of CI₂ gas. FIGS. 15 and 16 illustrate an etch profile when the C₂ F₆/Cl₂ ratio in an etch gas is 1:1 and an etch profile when the C₂ F₆/Cl₂ ratio in an etch gas is 2:1 , respectively.

The results as shown in FIGS. 15 and 16 are obtained under the following etch conditions. An etch gas was a mixed gas of 30% of C₂F₆/Cl₂ and 70% of Ar. In the case of FIG. 15, the ratio of C₂ F₆ to Cl₂ is 1:1. In the case of FIG. 16, the ratio of C₂ F₆ to Cl₂ is 2:1 . Coil RF power was set to 700 W, a gas pressure was set to 5 mTorr, a bias voltage to a substrate was set to 300 V, and a total flow rate was set to 30 sccm.

When the C₂ F₆/Cl₂ ratio is 1:1 , a few etch residues remain on the sidewalls of an etched Ir film, as shown in FIG. 15. When the C₂F₆/Cl₂ ratio is 2:1 , no etch residue remains on the sidewalls of an etched Ir film, as shown in FIG. 16. Accordingly, it is preferable that a C₂ F₆/Cl₂ ratio is 2:1 or greater when a mixed gas of C₂F₆/Cl₂ and Ar is used as an etch gas.

The features of a method of etching an Ir film for an Ir electrode according to an embodiment of the present invention are that a photoresist is used as a mask, etching is performed at room temperature without heating a substrate, and a high density plasma etching apparatus using inductively coupled plasma is used. In addition, C₂F₆/Ar gas (C₂F₆ gas is 30% or more) or a mixed gas of C₂F_{6,} Cl₂ and Ar ((C₂F₆ +Cl₂) gas is 30% or more, and a C₂F₆/CI₂ ratio is 2:1 or greater) is used as etch gas. The etch conditions are that a coil RF power is 500 W or greater, a gas pressure is 10 mTorr or lower, and a bias voltage applied to a substrate is 200 V or larger.

The fluorine-based gas C₂ F₆ may be replaced with CF₄, C₃F₈ or SF₆. The inert gas Ar may be replaced with He, Ne, Kr or N₂. As described above, a metal film is etched at room temperature without heating a substrate. The etch gas is preferably further contain a chlorine-based gas such as Cl₂, BCl₃ or SiCl₄. The content of the fluorine-based gas and the chlorine-based gas with respect to an inert gas in an etch gas is 30% or more. In particular, it is preferable that the fluorine-based gas/chlorine-based gas ratio is 2:1 or greater.

According to a conventional dry etching method for patterning electrodes formed of noble metals, a substrate should be heated to a high temperature, and Cl₂ or BCl₃ is usually used as an etch gas, so etch residues unavoidably remain on the surfaces of patterned electrodes. Accordingly, a cleaning process for removing the etch residues is required. However, when an Ir film is etched according to an embodiment of the present invention, no etch residues remain even if a photoresist is used as an etch mask, and it is not necessary to heat a substrate to a high temperature. In addition, since the selectivity of an Ir electrode with respect to a photoresist mask can be increased, an Ir electrode having a satisfactory etch profile can be formed.

Although the invention has been described with reference to particular embodiments, it will be apparent to one of ordinary skill in the art that modifications of the described embodiments may be made without departing from the spirit and scope of the invention. The embodiments of the present invention should be construed in a descriptive sense only and not for purposes of limitation. The scope of the invention will be defined by the attached claims.

What is claimed is:

1. A dry etching method for an iridium electrode, comprising:
depositing an iridium metal film on a substrate;
forming a photoresist mask on the metal film in a predetermined pattern;
etching the metal film which is not covered by the photoresist mask in the predetermined pattern by generating plasma using an etch gas containing an inert gas and a fluorine-based gas; and
removing the photoresist mask.

2. The dry etching method of claim 1, wherein the fluorine-based gas is selected from the group consisting of C₂F₆, CF₄, C₃F₈ and SF₆.

3. The dry etching method of claim 1, wherein the inert gas is selected from the group consisting of Ar, He, Ne, Kr and N₂.

4. The dry etching method of claim 2, wherein the inert gas is selected from the group consisting of Ar, He, Ne, Kr and N₂.

5. The dry etching method of claim 1, wherein the plasma is generated by a high density etching apparatus using inductively coupled plasma.

6. The dry etching method of claim 2, wherein the plasma is generated by a high density etching apparatus using inductively coupled plasma.

7. The dry etching method of claim 3, wherein the plasma is generated by a high density etching apparatus using inductively coupled plasma.

8. The dry etching method of claim 4, wherein the plasma is generated by a high density etching apparatus using inductively coupled plasma.

9. The dry etching method of claim 1, wherein the metal film is etched at room temperature without heating the substrate.

10. The dry etching method of claim 2, wherein the metal film is etched at room temperature without heating the substrate.

11. The dry etching method of claim 3, wherein the metal film is etched at room temperature without heating the substrate.

12. The dry etching method of claim 4, wherein the metal film is etched at room temperature without heating the substrate.

13. The dry etching method of claim 5, wherein the metal film is etched at room temperature without heating the substrate.

14. The dry etching method of claim 6, wherein the metal film is etched at room temperature without heating the substrate.

15. The dry etching method of claim 7, wherein the metal film is etched at room temperature without heating the substrate.

16. The dry etching method of claim 8, wherein the metal film is etched at room temperature without heating the substrate.

17. The dry etching method of claim 1, wherein the etch gas contains 30% or more fluorine-based gas.

18. The dry etching method of claim 2, wherein the etch gas contains 30% or more fluorine-based gas.

19. The dry etching method of claim 3, wherein the etch gas contains 30% or more fluorine-based gas.

20. The dry etching method of claim 4, wherein the etch gas contains 30% or more fluorine-based gas.

21. The dry etching method of claim 13, wherein the etch gas contains 30% or more fluorine-based gas.

22. The dry etching method of claim 14, wherein the etch gas contains 30% or more fluorine-based gas.

23. The dry etching method of claim 15, wherein the etch gas contains 30% or more fluorine-based gas.

24. The dry etching method of claim 16, wherein the etch gas contains 30% or more fluorine-based gas.

25. The dry etching method of claim 5, wherein the etch gas contains 30% or more fluorine-based gas.

26. The dry etching method of claim 6, wherein the etch gas contains 30% or more fluorine-based gas.

27. The dry etching method of claim 7, wherein the etch gas contains 30% or more fluorine-based gas.

28. The dry etching method of claim 8, wherein the etch gas contains 30% or more fluorine-based gas.

29. The dry etching method of claim 9, wherein the etch gas contains 30% or more fluorine-based gas.

30. The dry etching method of claim 10, wherein the etch gas contains 30% or more fluorine-based gas.

31. The dry etching method of claim 11, wherein the etch gas contains 30% or more fluorine-based gas.

32. The dry etching method of claim 12, wherein the etch gas contains 30% or more fluorine-based gas.

33. The dry etching method of claim 1, wherein the etch gas further contains chlorine-based gas.

34. The dry etching method of claim 2, wherein the etch gas further contains chlorine-based gas.

35. The dry etching method of claim 3, wherein the etch gas further contains chlorine-based gas.

36. The dry etching method of claim 4, wherein the etch gas further contains chlorine-based gas.

37. The dry etching method of claim 33, wherein the content of the fluorine-based gas and chlorine-based gas with respect to the inert gas is 30% or more.

38. The dry etching method of claim 34, wherein the content of the fluorine-based gas and chlorine-based gas with respect to the inert gas is 30% or more.

39. The dry etching method of claim 35, wherein the content of the fluorine-based gas and chlorine-based gas with respect to the inert gas is 30% or more.

40. The dry etching method of claim 36, wherein the content of the fluorine-based gas and chlorine-based gas with respect to the inert gas is 30% or more.

41. The dry etching method of claim 37, wherein a fluorine-based gas/chlorine-based gas ratio is 2:1 or greater.

42. The dry etching method of claim 38, wherein a fluorine-based gas/chlorine-based gas ratio is 2:1 or greater.

43. The dry etching method of claim 39, wherein a fluorine-based gas/chlorine-based gas ratio is 2:1 or greater.

44. The dry etching method of claim 40, wherein a fluorine-based gas/chlorine-based gas ratio is 2:1 or greater.

45. The dry etching method of claim 33, wherein the chlorine-based gas is selected from the group consisting Of Cl₂, BCI₃ and SiCI₄.

46. The dry etching method of claim 34, wherein the chlorine-based gas is selected from the group consisting of CI₂, BCI₃ and SiCI₄.

47. The dry etching method of claim 35, wherein the chlorine-based gas is selected from the group consisting of CI₂, BCI₃ and SiCI₄.

48. The dry etching method of claim 36, wherein the chlorine-based gas is selected from the group consisting of Cl₂, BCI₃ and SiCI₄.

49. The dry etching method of claim 37, wherein the chlorine-based gas is selected from the group consisting of CI₂, BCI₃ and SiCI₄.

50. The dry etching method of claim 38, wherein the chlorine-based gas is selected from the group consisting of Cl₂, BCI₃ and SiCI₄.

51. The dry etching method of claim 39, wherein the chlorine-based gas is selected from the group consisting of Cl₂, BCI₃ and SiCI₄.

52. The dry etching method of claim 40, wherein the chlorine-based gas is selected from the group consisting of Cl₂, BCI₃ and SiCI₄.

53. The dry etching method of claim 5, wherein the coil radio frequency power of the plasma etching apparatus is 500 W or greater, the gas pressure is 10 mTorr or higher, and the bias voltage of the substrate is 200 V or greater.

54. The dry etching method of claim 6, wherein the coil radio frequency power of the plasma etching apparatus is 500 W or greater, the gas pressure is 10 mTorr or higher, and the bias voltage of the substrate is 200 V or greater.

55. The dry etching method of claim 7, wherein the coil radio frequency power of the plasma etching apparatus is 500 W or greater, the gas pressure is 10 mTorr or higher, and the bias voltage of the substrate is 200 V or greater.

56. The dry etching method of claim 8, wherein the coil radio frequency power of the plasma etching apparatus is 500 W or greater, the gas pressure is 10 mTorr or higher, and the bias voltage of the substrate is 200 V or greater.

57. The dry etching method of claim 1, wherein the photoresist mask is removed using oxygen plasma.
